(19) United States
(12) Patent Application Publication
(10) Pub. No.: US 2023/0397569 A1
(43) Pub. Date: Dec. 14, 2023

(54) AUTOMATIC SELF-SUFFICIENT TOILET FOR HOUSEHOLD PETS

(71) Applicant: Ivan Andreevich ZAVODSKOV, Krasnodar (RU)

(72) Inventor: Ivan Andreevich ZAVODSKOV, Krasnodar (RU)

(21) Appl. No.: 18/035,031

(22) PCT Filed: Nov. 1, 2021
(86) PCT No.: PCT/RU2021/000479

§ 371 Date: May 2, 2023

(30) Foreign Application Priority Data
Nov. 3, 2020 (RU) 2020136481

(51) Int. Cl. A01K 1/01

(52) U.S. Cl. CPC A01K 1/0117; A01K 29/005

(57) ABSTRACT

An automatic toilet for household pets comprises a housing having in its upper part a tray that is fastened to load-bearing side plates and has a depression for receiving an animal. The bottom of the tray is inclined and has a drainage hole. Arranged in the upper part of the tray is a conveyor configured in the form of a modular perforated conveyor belt with holes. Arranged in two rows above the conveyor belt are optical sensors. Arranged to the left and right of the modular conveyor belt are a scraper and a roller brush which are protected by covers and abut the conveyor belt across its entire width. Disposed above the site where the scraper and the roller brush respectively abut the conveyor belt is a tube with holes, which is connected to a tube for filling the tray with water.

### FIELD OF THE INVENTION

The claimed invention relates to items for the care of pets, in particular, to an automatic pet toilet to foster comfort, hygiene and convenience of keeping pets.

### PRIOR ART

Pet toilets of various designs are widely known, for example, the so-called disposable, (U.S. Pat. No. 6,095,088 “Pet litter box assembly”), including special trays and boxes that are partially filled with sand, sawdust or other fillers, for the absorption of urine and excrement. Disposable toilets also include pet toilets that contain a disposable bag with filler, which has a fold for a larger volume in the unfolded state (Patent of the Russian Federation No. 164307).

At the same time, the use of such toilets requires manual cleaning with the replacement of the filler, which is extremely inconvenient when using them at home in terms of sanitation and hygiene. And the use of the filler can cause dust and sticking to the pets' paws when they leave the toilet.

This problem is partially solved by the use of trays consisting of two parts, the upper, which is removable, while the filler is located in the lower part, which ensures better sanitization of the tray and prevents the filler from sticking to the paws of the pet.

Another group is made up of technical solutions in which, for example, a diaper is used to collect excrement. In particular, patent application US 2009241850 describes a pet toilet comprising a body with a horizontal platform and a diaper movement mechanism with two axes mounted in the housing on opposite transverse sides of the platform and a rewind drive moving a clean diaper located in a roll on the first axis to the platform and a diaper with excrement along the platform into a roll on the second axis.

To improve sanitary and hygiene conditions is possible to use, for example, a pet toilet made in the form of a waste storage receiver, which can be a toilet, an overhead cover and a hatch closed with a single or double-leaf rotary door with a hole overlapping in the initial position with a gate valve, kinematically connected with the lid and spring-loaded relative to the sash (Patent of the Russian Federation No. 2203537).

Currently, there is a need for pet toilets that can be cleaned without human assistance that is achieved using partial automation, i.e. there is no need to remove excrement manually.

There is an automatic pet toilet which includes a base of a rectangular structure in the form of a container with sides and a bottom, as well as a drain funnel, above which the grille is placed; in addition, the device contains a tank with a locking mechanism with a valve placed in it, while the container and the tank are connected to each other; the device also contains a rectangular-shaped frame, wherein the frame is movably connected to the base by means of an axis with the possibility of changing an inclination angle; a drain siphon is attached to the tank on the opposite side of the tank, and the container is made with inclined sides and rounded corners at the bottom and fixed with a tank on the frame, in addition, the device contains a mechanism for controlling the movement of the tank, located in the body, at the bottom of which there is a locking element including a notch interacting with the pin, at the same time the body of the control mechanism is fixed on the base with the open part directed inside; in addition, a plate is movably fixed on the frame, in which a pin interacting with the notch of the locking element is rigidly fixed, and the drain drive mechanism is made in the form of a system of levers fixed movably on the frame and on the basis (Patent of the Russian Federation No. 2377768, cl. A01K 23/00, 2008).

However, this device is characterized by the complexity of the design due to the presence of a large number of parts interacting with each other mechanically. At the same time, there is no leak control system, since the discharge of water from the barrel occurs immediately after the animal has left the toilet, without any pauses, that are likely to frighten the animal. Since there is a grille above the funnel, the ingress of solid excrement into the funnel will prevent the qualitative cleaning of the latter. Thus, it is not possible to attribute the device to ‘autonomous’ even after a short operation, which reduces the reliability of the device and, accordingly, sanitary hygiene and convenience of keeping a pet.

There is also a pet toilet containing a housing with a recess and a floor, a siphon with a hydraulic shutter function containing a receiving part, at least one nozzle for flushing animal waste into the receiving part of the siphon; the stated floor of the hull is made with an inclination to the receiving hole of the siphon, and the device further comprises at least one lower nozzle located in the receiving part of the siphon, providing a stream of water directed at an angle to the walls of the siphon—means of supplying water to the nozzles, a sensor for the animal presence in the toilet, a nozzle control unit and a power supply unit (Patent of the Russian Federation No. 166209, cl. A01K 23/00, 2016).

However, the flushing device uses high-pressure nozzles, for the normal operation of which an appropriate pressure in the water supply system is needed. The lack of a pump and the abundant amount of water needed to flush the faces leads to a ‘hanging’ of the solid animal excrement in the receiving hole of the siphon, which may result in the occurrence of a clog reducing the reliability of the device during operation. In addition, during the operation of the high-pressure nozzle, a finely dispersed suspension of the animal's excrement will be formed, as well as soaking of the animal's paws in its own excrement will take place, and as a result, a violation of the sanitary and hygienic condition in the house.

The closest analogue is an automatic pet toilet containing a body on which a sink with shafts is mounted, between which a conveyor belt, a drain hole, nozzles, a power button, an indicator light with the ability to connect the device to the water supply and sewerage system are mounted, while the rigidity of the conveyor belt provides the location of a table under the top of the tape, which, being fixed on one side of the sink, freely presses the second end on the strain gauge, providing a signal of the animal presence for the microcontroller, while the valve supplies water through the nozzles installed flush on the bottom of the sink and in the first third of the lower side of the conveyor belt, the gear motor rotates the shaft, driving the belt, the water level sensor controls the threshold value of the water level, there is a shredder and an exhaust pump in the drain hole (Patent of the Russian Federation No. 171732, prototype).

However, the significant disadvantages of this device is the use of an endless conveyor belt, when it hits liquid excrement, the latter will spread over the entire surface, the paws of the animal will be stained, and thereby, the remains of the animal's waste products will be carried throughout the house. Underneath the conveyor belt there is a table to ensure the rigidity of the conveyor belt. Due to the direct contact of the continuous conveyor belt with the table, ventilation is insufficient. When the nozzles supply water to the belt, the latter does not provide planar spraying of water, due to insufficient pressure in the water supply network, which means high-quality cleaning of the surface of the conveyor belt. That reduces the reliability of the device and violates the sanitary and hygienic condition in the lodge.

### DISCLOSURE OF THE INVENTION

The technical task is to increase the reliability of the standalone automatic pet toilet and improve the sanitary and hygienic condition in the house.

The technical problem is solved by the fact that the standalone automatic pet toilet has a decorative case, in the upper part of which there is a tray fixed on the bearing side plates of the case and there is a recess to accommodate the pet; the bottom of the tray is made with an inclination and has a drain hole; a modular perforated conveyor belt with maximum holes of 6×10 mm is planted on shafts, also fixed on the side plates of the case; above the modular perforated conveyor belt there are two rows of optical fixation sensors: the upper and lower rows, and the upper row is located at a distance of 50-55 mm from the surface of the belt, the lower row—at a distance of 10-15 mm. To the left and right of the modular perforated conveyor belt there is a scraper and a brush shaft, which are protected by casings. The housings are fastened with screws to the supporting side plates of the housing. The scraper is adjacent to the perforated conveyor belt along its entire width with a gap of 2-4 mm. The gap between the scraper and the bottom of the tray is 8-12 mm. The brush shaft is also adjacent to the modular perforated conveyor belt across its entire width. Above the junction of the brush shaft at a height of 25-30 mm from the modular perforated conveyor belt there is a tube with holes which, in its turn, is connected to the tube for filling the tray with water by means of a tee connected to the water supply valve and then to the water supply hose, which, in its turn, is connected to the water supply. The tube for filling the tray with water is placed on its back wall and fixed with clamps, and it has a larger diameter than a tube with holes. At the bottom of the case there is a sealed and vibration-soundproof engine compartment, which has mounting holes for quick access to its internal space. In the engine compartment there is an electric gear motor for driving a perforated conveyor belt, an electric gear motor for driving the brush shaft, a shredder assembly with an electric motor that has a separate housing, a pup, a cooler for cooling the electric shredder motor, a cooler for forced ventilation of the engine compartment, a water leak sensor, a drain hose, a water supply hose, a rubber pipe connecting the drain hole of the tray and the shredder. The microcontroller has two cleaning cycle programs: short and standard. Moreover, the increase in the reliability of the claimed device is that it allows you to leave the animal without the presence of a person for several days, subject to the mandatory connection of the device to technical networks. The presence of a cooler for cooling the electric motor-shredder and a cooler for forced ventilation of the engine compartment, prevents overheating of the engine compartment. An emergency situation in case of water leakage is prevented by a water leakage sensor. All these contribute to the reliable autonomous operation of the claimed device without constant human control. The modular perforated conveyor belt has sufficient rigidity and can withstand a pet even with a large weight. Moreover, the moving parts (shafts, scraper, brush shaft) are enclosed in protective casings, which prevents not only splashing of water droplets, but also possible injury to the animal. The top row of optical fixation sensors monitors the presence of the animal, and in the event of its return, stops the cleaning cycle. The engine compartment is sealed, vibro-sound insulated, which during cleaning does not frighten the animal and does not cause discomfort to a person. The presence of two programs for cleaning cycles—short and standard—allows you to save water and electricity. The perforated modular conveyor belt provides not only drainage of liquid excrement, eliminating soaking of the animal's paws, but also ventilation and rapid drying of the belt surface and the internal space of the tray. The adjoining of the scraper to a modular perforated conveyor belt along its entire width with a gap of 2-4 mm contributes to its qualitative cleaning from excrement, and the gap between the scraper and the bottom of the tray does not allow the suspension of excrement with water to fall on the modular tape again. That improves the sanitary and hygienic condition in the house.

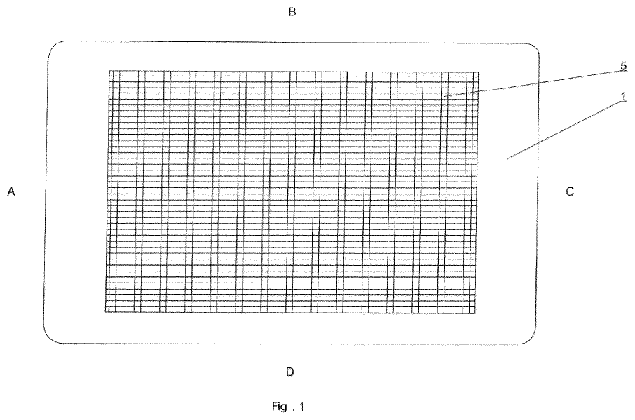

FIG. 1 shows the general top view of the device with the designation of the sides A-B-C-D.

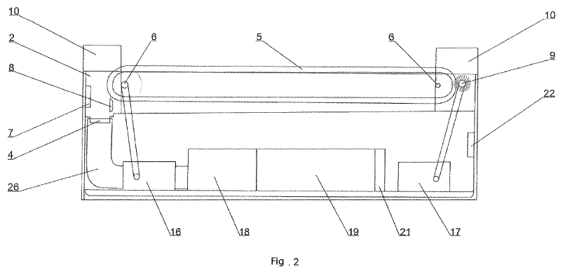

FIG. 2—side D.

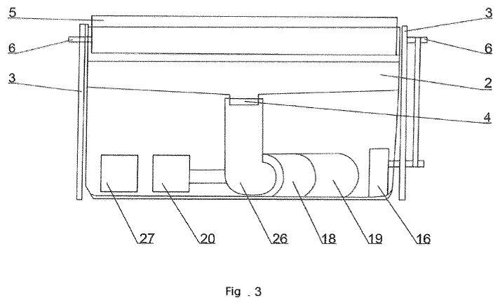

FIG. 3—side A.

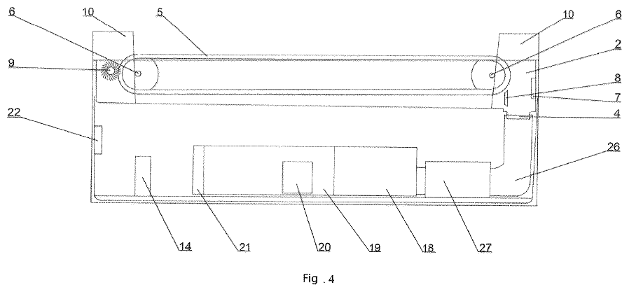

FIG. 4—side B.

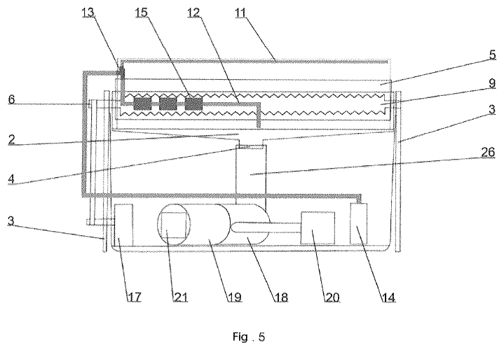

FIG. 5—side C.

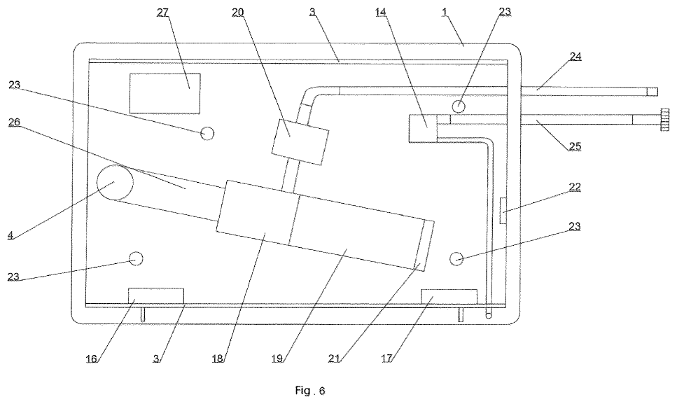

FIG. 6—engine compartment.

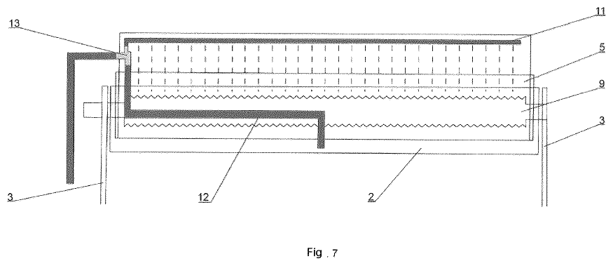

FIG. 7—brush shaft irrigation unit (rear view).

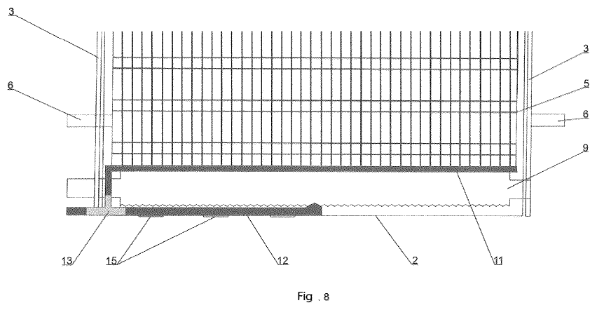

FIG. 8—brush shaft irrigation unit (top view).

The device consists of a decorative body 1, which has two parts—the upper and lower, where the lower is the engine compartment. At the top of decorative housing 1 there is tray 2 fixed on bearing side plates 3 of housing 1. Tray 2 has a recess to accommodate the pet. The bottom of tray 2 is tilted and has a drain hole 4. At the top of tray 2 there is a modular perforated conveyor belt 5 with holes of 6×10 mm. Tape 5 is mounted on shafts 6 fixed on side plates 3 of body 1. Water level sensor 7. To the left and right of modular perforated conveyor belt 5 there is scraper 8 and brush shaft 9, which are protected by housings 10. Housings 10 are fastened by screws to supporting side plates 3 of housing 1. Above the junction of brush shaft 9 and modular perforated conveyor belt 5 there is a tube with holes 11, which, in its turn, is connected to the water filling tube of tray 12 by means of tee 13 connected to water supply valve 14. The tube for filling the tray with water 12 is fixed by clamps 15 on the back wall of tray 2. At the bottom of body 1 there is an engine compartment. The engine compartment is made in the form of a rectangular plastic bowl with high edges and an open top. In the engine compartment of housing 1 there is electric gear motor 16 for driving perforated conveyor belt 5, electric gear motor 17 for driving brush shaft 9, shredder 18 assembled with electric motor 19 that has a separate housing, pump 20, cooler 21 for cooling electric shredder motor 19, cooler 22 for forced ventilation of the engine compartment, water leak sensor 23, drain hose 24, water supply hose 25, rubber pipe 26 connecting the drain hole of tray 4 and shredder 18 and microcontroller 27.

A display may be integrated into decorative housing 1 (not indicated in the drawing).

Tray 2 is made of plastic.

Scraper 8 adjoins tape 5 across its entire width with a gap of 2-4 mm. The gap between scraper 8 and the bottom of tray 2 is 8-12 mm.

Brush shaft 9 adjoins modular tape 5 across the entire width.

Tube with holes 11 is located above the junction of brush shaft 9 to modular perforated conveyor belt 5 at a height of 25-30 mm. Tube 12 for filling tray 2 with water has a larger diameter than tube with holes 11.

Microcontroller 27 has two cleaning cycle programs, a short one and a standard one. It can also be supplemented with programs for SMS-notification to the owner of the animal about an emergency situation or included in the ‘smart home’ program.

Water leak sensor 23 is triggered in the event of an emergency.

Modular perforated conveyor belt 5 has sufficient rigidity that allows to withstand an animal with a large weight and is made of a safe plastic designed for the food industry and resistant to various aggressive environments.

Above modular perforated conveyor belt 5 in two rows there are optical fixation sensors: upper and lower (not indicated in the drawing). The top row of optical fixation sensors is located at a distance of 50-55 mm from the surface of tape 5, the bottom row—at a distance of 10-15 mm. The bottom row of optical fixation sensors, after determining the presence or absence of excrement on modular tape 5, transmits this information to microcontroller 27 to enable one of the two cleaning cycles.

The device works as follows:

Optical fixation sensors record the moment the animal visiting the standalone automatic toilet, transmit this information to microcontroller 27, which after 30-90 seconds runs one of the cleaning cycle programs. After the animal has left the toilet, the microcontroller gives a signal to water supply valve 14 to open. Water enters the tray via tube 24, as long as water level sensor 7 does not disconnect water supply valve 14. Next, microcontroller 27 instructs geared motor 16 to scroll modular perforated conveyor belt 5 from shaft to shaft. During this time, optical fixation sensors detect the presence or absence of excrement on the modular tape, and in the absence of it, microcontroller 27 starts a short cleaning cycle.

During a short cleaning cycle, modular tape 5 is scrolled, brush shaft 9 cleans the surface of modular tape 5. Water and urine through the openings in modular perforated conveyor belt 5 enter the lower part of tray 2, and through branch pipe 26 with pump 20 are pumped into the sewer. Shredder 18 is not included.

In the case of fixation of excrement by optical sensors on modular perforated conveyor belt 5, microcontroller 27 starts a standard cleaning cycle. Modular perforated conveyor belt 5 is scrolled, brush shaft 9 and scraper 8 clean the surface of the belt and clean the excrement. Excrement enters the lower part of tray 2, from where through branch pipe 26 to shredder 18. From where through pump 20 it enters the sewer. In the case of adhesion of excrement on a modular perforated conveyor belt, the scraper cleans it, overlapping the gap between the bottom of the belt and the bottom of the tray, which does not allow the resulting suspension to enter the tray at the time of collecting water and settle on the bottom of the latter.

In the case of returning an animal to the toilet, for example, the top row of optical fiction sensors instantly detects its presence, and the cleaning cycle stops. The cycle resumes only when the animal leaves the toilet again.

### INDUSTRIAL APPLICABILITY

The use of the claimed invention makes it possible to manufacture devices that are completely autonomous and capable of functioning without human attention for 2 to 3 days, subject to the mandatory connection of the device to technical networks (water supply—sewerage).

1. Standalone automatic pet toilet, containing a body, conveyor belt, drain hole, animal presence indicator, microcontroller, water supply valve, water level sensor and shredder characterized in that the body is decorative, in the upper part of which there is a tray fixed on the bearing side plates of the body and there is a recess to accommodate the pet; the bottom of the tray is made with an inclination and has a drain hole; the conveyor tape is made in the form of a modular perforated conveyor belt with holes of 6×10 mm and is mounted on shafts, also fixed on the side plates of the body; optical fixation sensors are placed above the modular perforated tape in two rows: the upper and lower, wherein the upper row is located at a distance of 50-55 mm, the lower row is located at a distance of 10-15 mm from the surface of the tape, to the left and right of the modular tape there are a scraper and a brush shaft, which are protected by casings, wherein the casings are attached by screws to the bearing side plates of the body, and the scraper is adjacent to the perforated conveyor belt along its entire width with a gap of 2-4 mm, and the gap between the scraper and the bottom of the tray is 8-12 mm, the brush shaft is also adjacent to the perforated conveyor belt along its entire width; above the junction of the brush shaft at a height of 25-30 mm from the perforated conveyor belt there is a tube with holes, which, in its turn, is connected to the tube for filling the tray with water by means of a tee connected to the water supply valve and further to the water supply hose, which, in its turn, is connected to the water supply, the tube for filling the tray with water is placed on its rear wall and fixed with clamps, wherein the tube has a larger diameter than the tube with holes, and in the lower part of the case there is a sealed and vibration-soundproof engine compartment, which is a rectangular plastic bowl with high edges and an open top, which has mounting holes for quick access to the internal space of the compartment, in which an electric gear motor is located to drive a perforated conveyor belt, an electric gear motor to drive a brush shaft, shredder assembly with electric motor, which has a separate housing, pump, cooler for cooling the electric motor-shredder, cooler for forced ventilation of the engine compartment, water leak sensor, drain hose, water supply hose, rubber branch pipe connecting the drain hole of the tray and the shredder, and the microcontroller has two cleaning cycle programs: short and standard.
